(19) United States
(12) Patent Application Publication
(10) Pub. No.: US 2022/0414470 A1
(43) Pub. Date: Dec. 29, 2022

(54) Multi-Task Attention Based Recurrent Neural Networks for Efficient Representation Learning

(71) Applicant: Cognitiv Corp., New York, NY (US)

(72) Inventors: Behnaz Nojavanasghari, Bellevue, WA (US); Aaron Andalman, Berkeley, CA (US)

(21) Appl. No.: 17/846,667

(22) Filed: Jun. 22, 2022

Related U.S. Application Data
(60) Provisional application No. 63/215,015, filed on Jun. 25, 2021.

(51) Int. Cl. G06N 3/08

(52) U.S. Cl. CPC G06N 3/08

(57) ABSTRACT

Systems, apparatuses, and methods for leveraging temporal user behavior, such as web browsing history or social media interactions, to “predict” the occurrence and/or timing of one or more subsequent events. A multi-task architecture models temporal user-behavior with respect to single or multiple objectives and optimizes the neural network architecture and task-grouping to achieve the most accurate predictions. The deep attention-based uni-directional or bi-directional recurrent neural network (RNN) models that are part of the disclosed architecture can be used directly as an end-to-end prediction or inference system or can be used to generate learned representations of temporal data which can be extracted and used in a separate model or architecture.

### CROSS REFERENCE TO RELATED APPLICATION

This application claims the benefit of U.S. Provisional Application No. 63/215,015, entitled “Multi-Task Attention Based Recurrent Neural Networks for Efficient Representation Learning,” filed Jun. 25, 2021, the disclosure of which is incorporated, in its entirety by this reference.

### BACKGROUND

The way in which data is represented can have a profound effect on the success of a machine learning algorithm in identifying patterns in that data, and the reliability of a resulting model. For example, an image could be represented as three matrices of RGB (red, green, blue) values, three matrices of HSV (hue, saturation) values, or as a matrix indicating the location of edges in the image. The chosen representation may impact the structure and operation of a trained model, and the inferences that can be drawn from the data.

Traditionally, the process of exploring data representations to optimize model performance is referred to as feature engineering. However, in machine learning (ML), representation learning often serves as a replacement for feature engineering, where representation learning refers to methods that allow a system to automatically “discover” the data representations needed or best suited for a machine learning task.

In tasks such as time-series classification, time-series forecasting, and time-series generation, representation learning has proved especially valuable. This is at least in part because capturing long(er) temporal dependencies between model features is a particularly challenging task for feature engineering. Further, while feature engineering is typically a manual and time-consuming task, representation learning algorithms can be used to discover a set of features for a given task with minimal (if any) human intervention, and the learned data representations often result in both better model performance and representations that can more rapidly adapt to new tasks.

For applications or tasks where sequential and time-series data in which patterns that exist across longer temporal spans are important, recurrent neural network (RNN) architectures have proven to be effective at generating learned representations. However, conventional implementations of these architectures have significant limitations. One limitation is the relatively high cost with respect to computational resources and labor that is needed to identify the optimal network and cell architecture for the RNN. While handcrafted cell structures and architectures can be used, a systematic and automatic way of generating and evaluating these architectures and cell structures would be expected to produce more accurate results.

Another limitation is the difficulty in addressing use cases involving multiple tasks, goals, or objectives. This can be a disadvantage when attempting to use trained models for real world business applications where there are often multiple, interrelated objectives that need to be optimized simultaneously for a model to be of practical value.

Embodiments are directed to solving these and other disadvantages of conventional approaches and architectures, either alone or in combination.

### SUMMARY

The terms “invention,” “the invention,” “this invention,” “the present invention,” “the present disclosure,” or “the disclosure” as used herein are intended to refer broadly to all the subject matter disclosed in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

In some embodiments, the disclosure is directed to systems, apparatuses, and methods for leveraging temporal user behavior, such as web browsing history or social media interactions, to “predict” the occurrence and/or timing of one or more subsequent events. These events may include but are not limited to (or required to include) user initiated “clicks” or other indications of a user selecting a link or user interface element, a website visit, a user's interactions with a website, or a purchase of a product or service, as examples.

Embodiments introduce a multi-task architecture that models temporal user-behavior with respect to single or multiple objectives (sometimes referred to as tasks or goals) and optimizes the neural network architecture and task-grouping to achieve the most accurate predictions. The deep attention-based uni-directional or bi-directional recurrent neural network (RNN) models that are part of the disclosed architecture can be used directly as an end-to-end prediction or inference system or can be used to generate learned representations of temporal data which can be extracted and used in a separate model or architecture.

Embodiments disclosed herein are directed to systems, apparatuses, and methods for generating a learned representation of temporal sequences of data or information with respect to single or multiple goals or objectives. The embodiments disclosed introduce an architecture which is able to: (1) model complex temporal sequences and deal with a variable length (short or long) sequence without manual effort, and offer interpretable insights on how the model is making predictions; and (2) optimize performance with respect to a single or multiple goals (expressed as objectives or metrics, for example) in a single end-to-end system, while allowing domain specific knowledge and auxiliary objectives to be considered to further improve the results.

In one embodiment, the disclosure is directed to a method for leveraging temporal user behavior, such as web browsing history or social media interactions, to “predict” the occurrence and/or timing of one or more subsequent events. The method may include the following steps, stages, functions, or operations:
Obtain a Sequential User Data Stream for Each of N Users;
For all Users, Convert all Sequence Elements into Vectors of a Fixed Dimensionality;
Assemble the Vectors Into a Multi-Dimensional Tensor;
Define a RNN Search Space and Generate an Initial (or subsequent) Candidate Neural Network;
Use the Tensor as Input to the Initial (or subsequent) Neural Network Architecture Found from the Search;
Determine the Performance of the Initial Neural Network Architecture (in later stages, the performance of a Candidate Architecture) and Underlying Representation for a Desired Task/Objective;
   The performance or accuracy measure/metric may be fed back into the controller or algorithm to assist in generating a “better” network architecture;
   The preceding processes may be repeated to identify a “best” neural network architecture (and underlying data representation) for each of one or more tasks or objectives;
Given a best or optimal neural network architecture for each of one or more tasks or objectives, define and evaluate an optimization problem to select the “best” combination of networks and tasks/objectives (i.e., the assignment of each task/objective or combination of tasks/objectives to a specific network architecture);
   This may include using a constraint on the total number of networks used for a set of tasks;
Select Architecture(s)/Representation(s) That Minimize Overall Loss While Satisfying the Constraint on Number of Allowed Neural Networks; and
Use the Selected Architectures to Generate Predictions for the Tasks they Have Been Assigned or Use the Last Hidden Layer of Selected Architectures as Input to a Subsequent Model.

In one embodiment, the disclosure is directed to a system for leveraging temporal user behavior, such as web browsing history or social media interactions, to “predict” the occurrence and/or timing of one or more subsequent events. The system may include a set of computer-executable instructions, a memory or data storage element containing the set of instructions, and an electronic processor or co-processors. When executed by the processor or co-processors, the instructions cause the processor or co-processors (or a device of which they are part) to perform a set of operations that implement an embodiment of the disclosed method or methods.

In one embodiment, the disclosure is directed to a set of computer-executable instructions, wherein when the set of instructions are executed by an electronic processor or co-processors, the processor or co-processors (or a device of which they are part) performs a set of operations that implement an embodiment of the disclosed method or methods.

In some embodiments, the systems and methods disclosed herein may provide services through a SaaS or multi-tenant platform. The platform provides access to multiple entities, each with a separate account and associated data storage. Each account may correspond to a user, a set of users, an entity, a set or category of entities, a set or category of users, a set or category of data, an industry, or an organization, for example. Each account may access one or more services, a set of which are instantiated in their account and which implement one or more of the methods or functions described herein.

Other objects and advantages of the systems, apparatuses, and methods disclosed will be apparent to one of ordinary skill in the art upon review of the detailed description and the included figures. Throughout the drawings, identical reference characters and descriptions indicate similar, but not necessarily identical, elements. While the embodiments disclosed or described herein are susceptible to various modifications and alternative forms, specific embodiments are shown by way of example in the drawings and will be described in detail herein. However, the exemplary or specific embodiments are not intended to be limited to the particular forms disclosed. Rather, the present disclosure covers all modifications, equivalents, and alternatives falling within the scope of the appended claims.

### BRIEF DESCRIPTION OF THE DRAWINGS

Embodiments of the disclosure will be described with reference to the drawings, in which:

FIG. 1 is a diagram illustrating a bi-directional attention-based RNN that may be used in modeling temporal sequences in some embodiments;

FIG. 2 is a diagram showing how an RNN or the data representations extracted from an RNN can be used as a part of a separate model;

FIG. 3(a) is a diagram illustrating the components of a neural network architecture search process that may be used in some embodiments;

FIG. 3(b) is a diagram illustrating a potential search algorithm in which a RNN controller samples a candidate architecture and eventually selects an architecture with the “best” performance;

FIG. 4(a) shows the cell structure and operation of a RNN cell;

FIG. 4(b) shows the cell structure and operation of a LSTM cell;

FIG. 4(c) shows an RNN cell structure that can be found by a neural network architecture search process;

FIG. 4(d) is a flow chart or flow diagram illustrating a process, operation, method, or set of functions for generating a representation for a sequence of data as part of a process of generating and evaluating candidate neural network architectures for use with that data. The figure also illustrates a process for determining an “optimal” assignment of one or more tasks or objectives to each of one or more of the candidate architectures, in accordance with some embodiments;

FIG. 4(e) is a diagram illustrating elements or components that may be present in a computing device, server, or system configured to implement a method, process, function, or operation in accordance with some embodiments;

FIG. 5(a) illustrates an example of a task-to-candidate neural network architecture assignment that may be implemented in some embodiments; and

FIGS. 5(b), 6, and 7 are diagrams illustrating an architecture for a multi-tenant or SaaS platform that may be used in implementing an embodiment of the systems, apparatuses, and methods disclosed herein.

### DETAILED DESCRIPTION

One or more embodiments of the disclosed subject matter are described herein with specificity to meet statutory requirements, but this description does not limit the scope of the claims. The claimed subject matter may be embodied in other ways, may include different elements or steps, and may be used in conjunction with other existing or later developed technologies. The description should not be interpreted as implying any required order or arrangement among or between various steps or elements except when the order of individual steps or arrangement of elements is explicitly noted as being required.

Embodiments of the disclosed subject matter will be described more fully herein with reference to the accompanying drawings, which show by way of illustration, example embodiments by which the disclosed systems, apparatuses, and methods may be practiced. However, the disclosure may be embodied in different forms and should not be construed as limited to the embodiments set forth herein; rather, these embodiments are provided so that this disclosure will satisfy the statutory requirements and convey the scope of the disclosure to those skilled in the art.

Among other forms, the subject matter of the disclosure may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods described herein may be implemented by a suitable processing element or elements (such as a processor, microprocessor, CPU, GPU, TPU, QPU, state machine, or controller, as non-limiting examples) that are part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory data storage elements. In some embodiments, the set of instructions may be conveyed to a user over a network (e.g., the Internet) through a transfer of instructions or an application that executes a set of instructions.

In some embodiments, the systems and methods disclosed herein may provide services to end users through a SaaS or multi-tenant platform. The platform provides access to multiple entities, each with a separate account and associated data storage. Each account may correspond to a user, a set of users, an entity, a set or category of entities, a set or category of users, a set or category of data, an industry, or an organization, for example. Each account may access one or more services (such as applications or functionality), a set of which are instantiated in their account, and which implement one or more of the methods, process, operations, or functions disclosed herein.

In some embodiments, one or more of the operations, functions, processes, or methods disclosed herein may be implemented by a specialized form of hardware, such as a programmable gate array, application specific integrated circuit (ASIC), or the like. Note that an embodiment of the disclosed methods may be implemented in the form of an application, a sub-routine that is part of a larger application, a “plug-in”, an extension to the functionality of a data processing system or platform, or other suitable form. The following detailed description is, therefore, not to be taken in a limiting sense.

Embodiments of the disclosure are directed to systems, apparatuses, and methods for leveraging temporal user behavior, such as web browsing history or social media interactions, to “predict” the occurrence and/or timing of one or more subsequent events. These events may include but are not limited to (or required to include) user initiated “clicks” or other indications of a user selecting a link or user interface element, a website visit, a user's interactions with a website, or a purchase of a product or service, as examples.

In some embodiments, to learn an efficient temporal representation of data with respect to single or multiple objectives, the disclosed architecture models the temporal behavior using an attention-based recurrent neural network. An optimal (or close to optimal) neural network architecture is selected using a search over factors that are important for performance, where these may include one or more of an activation function, a connectivity pattern, a number of nodes, and/or a number of layers, as non-limiting examples.

After identifying one or more “best” candidate neural network architectures based on the capacity of a network to learn a single or multiple tasks and one or more performance metrics, the disclosed approach forms and generates a solution to an optimization problem that determines a task-to-candidate architecture mapping or grouping, where this mapping determines the optimal candidate network architecture to predict each task. This approach helps to prevent negative transfer (where tasks may interfere with each other and reduce the model performance) and allows a final model to leverage information contained in related objectives. This results in fewer models being needed compared to having a separate model for each task.

The disclosed approach has the advantages (among others) of a decreased training and inference time, improved overall accuracy and generalization of the models, and increased sample efficiency for tasks (where this refers to the amount of labeled data an algorithm needs in a particular situation to result in a desired level of performance for a model). These advantages are particularly important in domains with sparse data, such as click-through rate and conversion prediction when those are used to evaluate the placement and effectiveness of advertisements presented to a specific user or set of users.

In some contexts, the disclosed approach may be used as part of a model that generates a recommendation of content or a communication to present to a user or group of users. The content or communication may be for purposes of marketing, sales, instruction, or customer support, as non-limiting examples.

Embodiments identify or develop an attention-based recurrent neural network (or set of such networks) that can be used to efficiently perform a specific task or tasks. This may include “optimizing” the allocation of tasks or objectives to one or more candidate networks based on a constraint as to the number of networks or models used to perform the set of tasks. Further, identifying an attention-based recurrent neural network capable of performing a task with a desired level of performance through a search and evaluation process can also yield a learned data representation, where typically, given an input to the network, the values of the last hidden layer within the network serve as an effective representation of the input.

The created representation layer can be extracted and used to represent the type of data being considered in other neural networks or models. This can accelerate the process of model development for the type of data and enable its use in other contexts and for other purposes. From one perspective, embodiments use a process to determine a desired neural network architecture (or architectures) to perform a specific task or tasks, and then use a layer of the architecture as the learned representation for a type of data that will be evaluated by the model or by another model.

Embodiments perform a neural network search and evaluation process to determine a candidate network architecture (and inherently, a desired data representation) for each of several tasks or objectives. Embodiments then determine which tasks or objectives may be grouped together and implemented using the same network architecture without a significant reduction in performance. The resulting set of one or more “optimal” architectures inherently contain a corresponding set of data representation layers which allow determining a “best” representation for a type of data when that data is intended to be used to perform a specific task or tasks. This is because if a specific network architecture is found to be optimal for a task or tasks, then the corresponding data representation layer is considered an optimal form for the data that is evaluated in performing that tasks or tasks.

In some embodiments, the disclosed approach may take the form of a set of nested searches, where in an inner-loop a process is performed to optimize the model architecture using a suitable technique (for example, Proximal Policy Optimization), and in the outer loop a process is performed to optimize the assignment of tasks to networks.

As a general observation, the performance of a system or process can sometimes be measured from multiple perspectives, such as being based on different metrics. The selected metrics may depend on the goal of a model (such as its intended use) or the type of data available, as examples. In the field of advertising, it is common to be interested in the click-through-rate, the view-through conversion rate, the viewability, and/or the margin, as examples.

While learned representations that are trained for an individual (i.e., a single) objective can achieve reasonable results, they may suffer from limited training data and often have a limited utility for use with other objectives, goals, or tasks. Furthermore, data representations optimized for a single objective may be sub-optimal when other objectives are closely related, since the representations are unable to exploit the additional data and underlying commonalities between the objectives. Additionally, when an investigator or user is interested in optimizing representations for, and predicting multiple objectives, it will typically take additional time to train or do inference using separate models or neural networks. This illustrates the potential benefits of being able to group more than a single task, goal, or objective together when determining an optimal neural network architecture.

However, while training for related tasks together may result in more optimal data representations and faster model training and inference time(s), this is not always the case, as not all seemingly related tasks prove to be compatible when trained together. Potential reasons for this incompatibility or sub-optimal behavior are that tasks may need to be learned at different rates, one task may dominate learning, gradients may interfere, or the optimization process may become difficult or impractical due to the required computational resources.

Further, there is no a priori methodology that may be used to determine which tasks train more effectively when grouped together, and the performance of a network may be sensitive to factors such as dataset size and network architecture choice. For example, the choice of neural network architecture that yields an optimal result for a single task (i.e., a single objective or goal) may not be optimal for multiple tasks because the model may need greater capacity to learn multiple tasks and exploit task interrelationships to produce a useful output.

As will be described, in one or more embodiments, a specific process may be used to determine several aspects of a model that is based on a machine learning algorithm and that is optimal in some sense for use in performing a task or tasks. These aspects may include determining one or more of:
A desirable neural network architecture for a model that is optimized for a task by “predicting” an outcome based on an objective function, and that may be described or defined in terms of one or more architectural parameters or characteristics;
   In some embodiments, these parameters or characteristics may include one or more of a learning rate, the terms of an optimizer, a size of filters, the structure of the cells of a network and its design (such as varying the structure of RNN cells or the choice of activation function), and/or related operations such as how to combine two nodes in a network;
A desirable neural network architecture for each task of a set or group of tasks;
   Depending upon the type or number of tasks, goals, or objectives being considered, an embodiment may generate more than a single candidate architecture, where each generated architecture is best suited for one or more of the tasks, goals, or objectives (where the tasks may be considered alone or in combinations);
      Thus, in some embodiments, the disclosed approach may determine an optimal neural network architecture for each task, for each pair of tasks, for each n-tuple of tasks, as examples;
A representation for the data being used to train each generated candidate architecture or model (and to represent the input data in the prediction/inference stage after a model is trained);
An assignment of each task, goal, or objective to one of the generated architectures, where that architecture is intended to be used as the basis for developing a trained model;
   In some embodiments, this may result in more than a single task being assigned to a specific architecture;
   In some embodiments, an optimization problem may be defined and evaluated to determine a “best” or “most-optimal” assignment of each of a group of tasks to the generated candidate architectures;
      In one embodiment, a maximum value may be set on the number of architectures used to accomplish the group of tasks, goals, or objectives;
         In this situation, the disclosed processes generate a “best” data representation, a “best” network architecture (as defined by the parameters or characteristics considered), and a “best” assignment of which data representation and architecture to utilize for performing each task (or goal or objective) in the group of tasks.
            As mentioned, in some embodiments, the disclosed approach may take the form of a set of nested searches, where in an inner-loop a process is performed to optimize the model architecture using a suitable technique (for example, Proximal Policy Optimization), and in the outer loop a process is performed to optimize the assignment of tasks to networks.

If sufficient computational resources are available, then one approach is to generate a separate data representation and neural network architecture for each task, goal, or objective, and then determine if the performance of a model changes in a significant manner when tasks, goals, or objectives are grouped in various combinations.

As a non-limiting example, an implementation of one or more embodiments of the disclosed neural network architecture selection and data representation learning system may be as follows:
In some embodiments, an input to the disclosed system is a set of sequential or temporally indexed data streams. For example, each of N users may be associated with browsing history data consisting of a sequence of URLs, where each data element in the sequence may be associated with a time at which the event (the navigation to a specific URL) occurred;
   In some embodiments, a first step or processing stage is converting each element of each sequence into a fixed size n-dimensional vector. For URLs specifically, an embodiment may use a separate process that utilizes semantic information to embed each URL in an n-dimensional space (this approach is described further below);
      This processing flow may also be applied to other temporal or sequential data that have different formats or representations. For example, a stream of speech can be embedded using a network that is trained to represent tone, pitch, or voice quality. Similarly, a video stream can be embedded using a network that is trained to represent objects that appear in the video or events that happen in the video stream;
      In one example embodiment, this process involves a preprocessing step in which each URL is parsed into a set of tokens and a separate machine learning algorithm performs the embedding function;
      In one embodiment, the system uses fastText, a pre-trained language model, to extract embeddings and form vector representations for each token in a URL. The system averages these representations for all tokens in each URL to get one “final” representation for a specific URL;
Iterating over all users using this processing flow results in a user-based dataset of a representation of user browsing history for the N users. The dataset may be represented by a multidimensional tensor of n×t×d dimensions, where n is the number of users, t is the number of URLs for each user (which typically differs among different users and is not a fixed size), and d is the feature dimensionality per each URL;
   Note that the parameter d has been optimized in a different system (as described previously) with respect to semantic and contextual value of each dimension to generate a representation for each URL;
The multidimensional tensor obtained from the user data and described processing flow is used as an input to the disclosed system, which in one embodiment is an attention based recurrent neural network (RNN) configured to handle a varying size sequence length. The recurrent neural network can be trained using a single objective or using multiple objectives (corresponding to a single or to more than a single task or goal). The network can then be used as an end-to-end system for prediction/inference, or the last hidden layer can be used as a learned data representation for input into a separate architecture or model;
   An example of such a scenario is when there are other sources of information available, such as static features corresponding to age, gender, education, or other demographic data of users which might be helpful in predicting an outcome. The learned representations can be combined with these features and provided as inputs to a different classifier (or other form of model) for a prediction or classification process. If trained using multiple objectives, then the resulting data representation(s) will be a shared, rich representation that may be used to predict the included objectives.

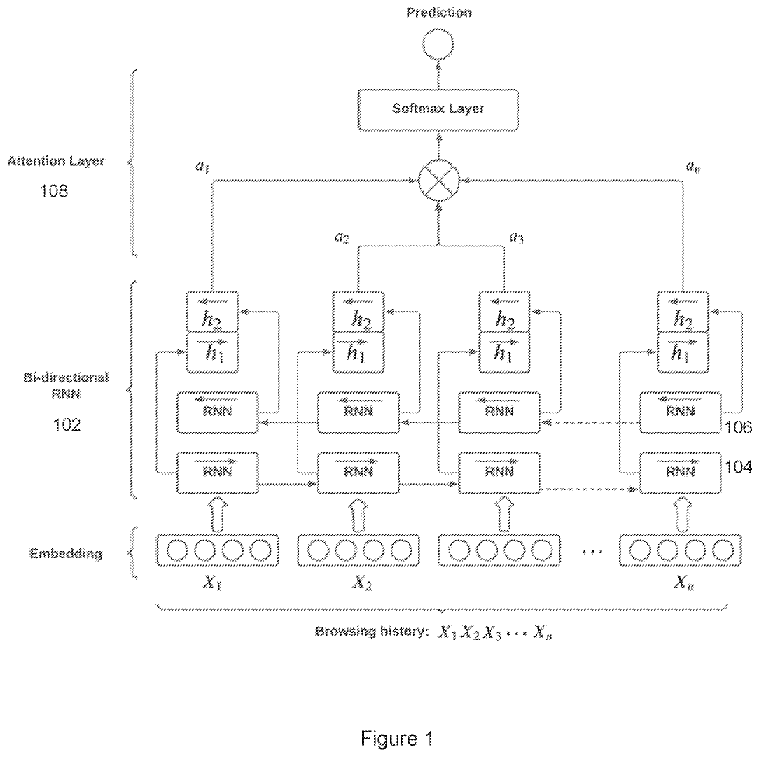

FIG. 1 is a diagram illustrating a bi-directional attention-based RNN 102 that may be used in modeling temporal sequences in some embodiments (and as described, may be used to generate optimal data representations). Recurrent Neural Networks (RNN) are a type of deep learning architecture that can handle varying length sequences in contrast to fixed dimensional static features. These networks (RNNs) have been shown able to capture dynamics in sequential data and represent the characteristics of a sequence.

A bi-directional RNN uses the outputs of two RNNs, one processing the sequence from left-to-right (as suggested by element or component 104), the other one from right-to-left (as suggested by element or component 106) and can create a rich(er) data representation. The attention layer (as suggested by element or component 108) acts on top of the RNN and serves to weight each element of the sequence based on how important it is for predicting the objective.

While model architectures can be designed by human experts and used for predicting single or multiple objectives, these design choices are typically made without exploring the possible network architecture space to find the “best” or most-optimal architecture. However, consideration of other potential architectures can be beneficial, as systematic and automated methods of learning model architectures typically result in higher performance while requiring less human effort.

The process of identifying an optimal or more optimal neural network architecture is termed neural architecture search. Neural networks represent a function or processing flow that transforms input variables (x) to output variables (y) through a series of operations. These operations may include unary operations such as convolutions, pooling, and activations, and/or n-ary operations such as concatenation or addition. Neural architecture search is based on using an auxiliary search algorithm (such as random search, manual search, evolutionary search, or reinforcement learning, as examples) to optimize the characteristics of a neural network.

These network characteristics can include parameters such learning rate, terms of the optimizer, and the size of filters. They may also relate to the structure of the cells of a network and the arrangement of the cells, such as varying the structure of RNN cells or the choice of activation function. The characteristics may also relate to operations such as how to combine two nodes in a candidate network.

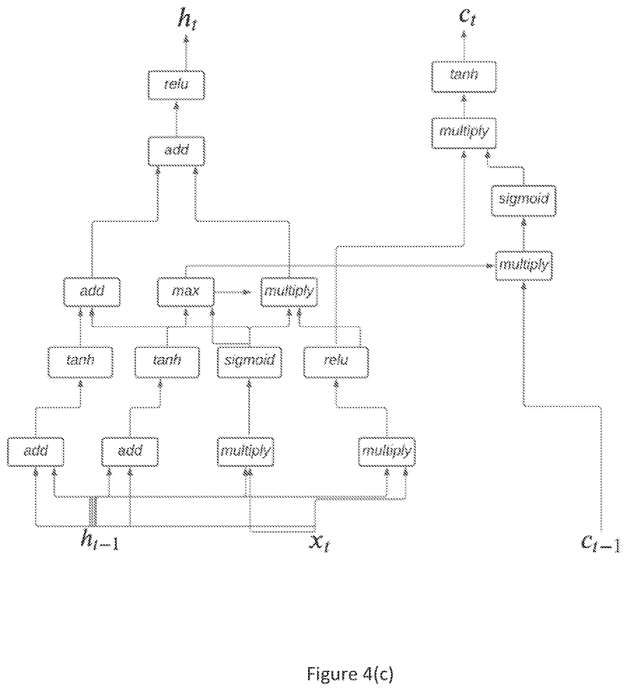

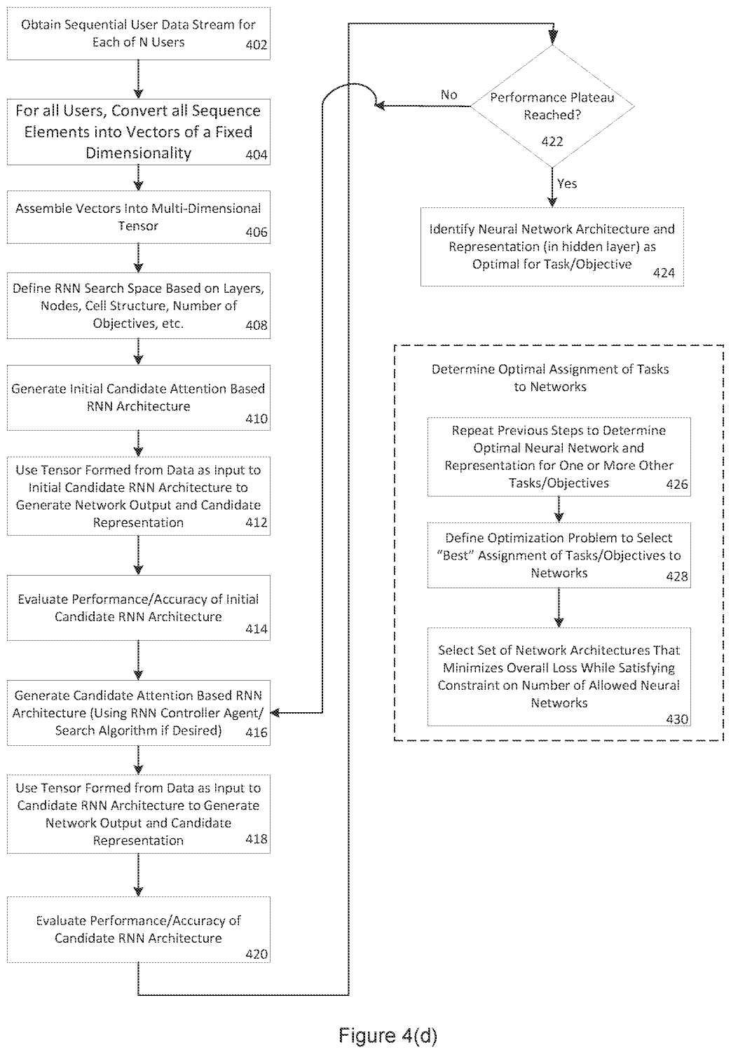

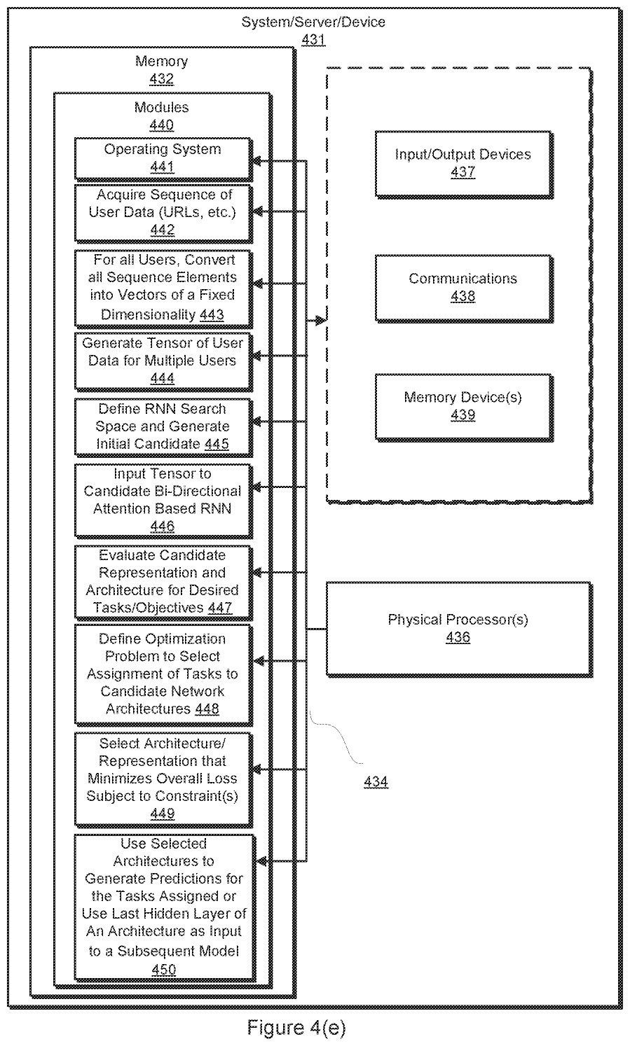

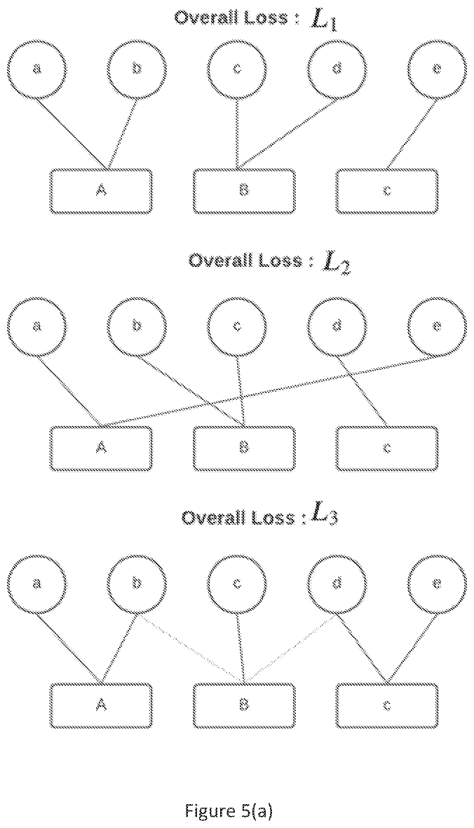

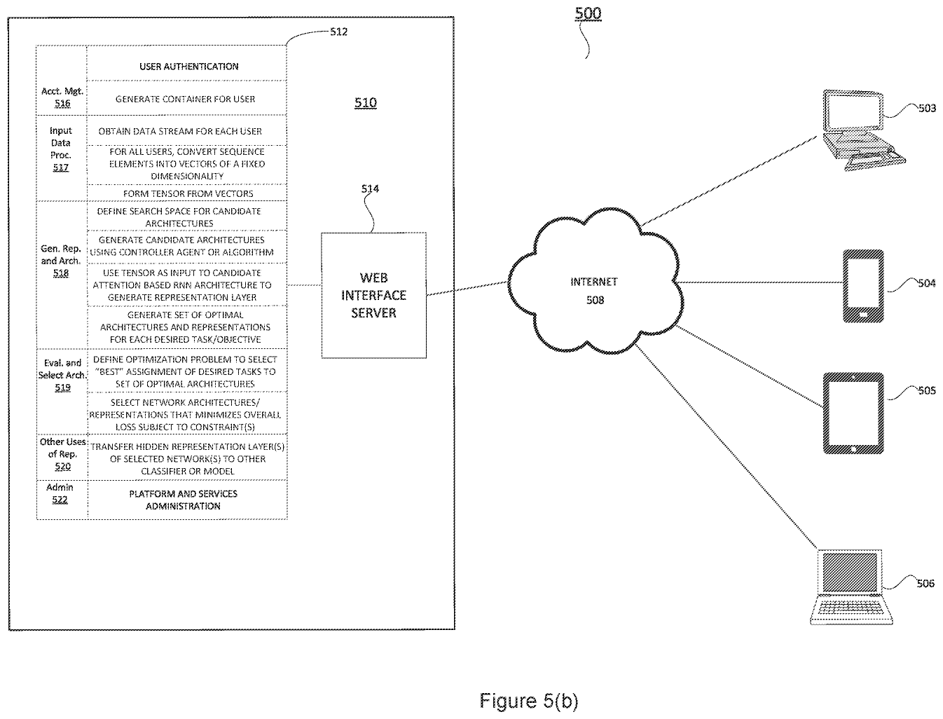

FIG. 4(a) is a diagram illustrating the cell structure of a RNN, with the corresponding description (in terms of variables and implemented functions) of its operation. FIG. 4(b) is a diagram illustrating the cell structure of a long short-term memory (LSTM) cell, with the corresponding description (in terms of variables and implemented functions) of its operation. Different types of RNN cells differ in the number of nodes and in the type of operations performed by each cell. Note that FIGS. 4(a) and 4(b) illustrate commercially available cells and can be used in an embodiment of the disclosure if the optimal network structure is not needed or desired.

FIG. 4(c) is a diagram illustrating an RNN cell structure that can be found by a neural network architecture search process. The illustrated RNN cell has a greater number of operations and functions, and a different arrangement of those operations and functions than the cell shown in FIG. 4(a). FIG. 4(c) illustrates a “custom” RNN cell that could theoretically be determined as optimal based on a neural network architecture search performed in accordance with the approach disclosed herein.

As mentioned, the impact of architecture choice may become even more important when a user moves from a model optimized for single task prediction and seeks an architecture that can leverage commonalities between related tasks to obtain an optimal multi-task prediction or inference model.

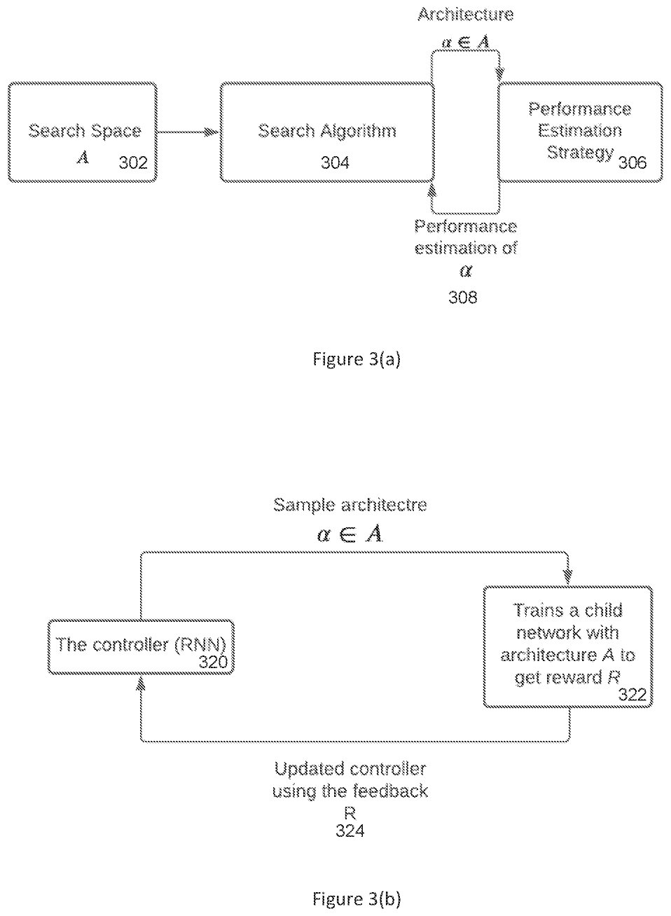

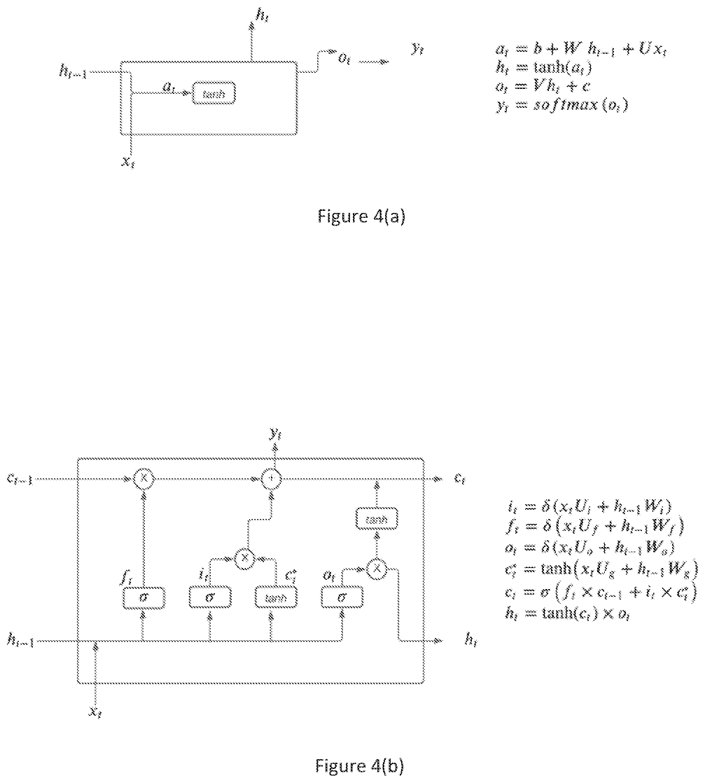

In some embodiments, choosing a more optimal or “better” neural network architecture may include the following primary steps or stages: (a) defining a search space (typically based on one or more parameters); (b) defining or selecting an algorithm to generate candidate architecture(s) within the search space; and (c) implementing an evaluation strategy for the generated candidate(s) to serve as a control signal to modify the search process. These functions are suggested by FIG. 3(a), which is a diagram showing the component elements or processes (and dimensions) of a neural network architecture search that may be used in identifying an optimal architectural candidate.

As suggested by the figure, the Search Space (A) 302 defines the possible set of parameter choices. The search algorithm (304) selects candidate neural network architectures based on the provided search space parameters. The performance of a candidate architecture is estimated (306) and fed back (as suggested by process flow 308) to the search algorithm (304) as a control signal to assist in selecting new candidates and converge to an optimal set of architectures based on the specified parameters.

Based on the “best” performing architectures that are identified and a set of tasks that are to be performed (i.e., a set of one or more predictions or inferences that are desired), a task-network optimization strategy is generated. In the generated strategy, each task is implemented by at least by one network. The strategy produces an optimal network architecture and task grouping (an assignment of each task to a network architecture, where more than one task may be assigned to be implemented by an architecture) and may be subject to a constraint on the total number of architectures used.

As discussed with reference to FIG. 3(a), in some embodiments, the disclosed system first defines a search space (A). In one embodiment, the search space is defined by neural network characteristics, and may comprise one or more of the number of layers, the number of hidden nodes, or the RNN cell structure. The disclosed system also selects an optimization approach or methodology (as suggested by Performance Estimation Strategy 306). The system then uses an approach or process flow such as the one disclosed herein to generate candidate networks that can be evaluated based on the estimated performance of the network for a task.

Note that there are multiple algorithms or heuristics that can be used to generate a candidate architecture. One approach is that of using reinforcement learning (RL) to train a controller (as suggested by element, component, or process 320 in FIG. 3(b)) to generate candidate architectures. In one embodiment, an RNN can be trained as the controller agent with an optimization algorithm (such as Proximal Policy Optimization, or PPO) being used to generate candidate architectures.¹ ¹ A description of one approach to determining a neural architecture is described in Pham, Hieu, et al., “Efficient Neural Architecture Search via Parameter Sharing”, https://arxiv.org/pdf/1802.03268.pdf.

Each of the generated candidate architectures can be evaluated based on a metric, with the result used as the “reward” (as suggested by element, component, or process 322 of FIG. 3(b)) in a feedback mechanism to train the controller (as suggested by feedback loop 324 of FIG. 3(b)). While it is desirable to search the entire search space (A) using a fully trained network, given the computational cost and required time, it is often impractical in a business setting. To compensate for this, the evaluation metrics may be chosen based on the objectives the system is being trained to predict, that is, by determining which architectures perform the best in predicting an objective, where the prediction performance can be evaluated in terms of accuracy, F1 score, or AVP, as non-limiting examples.

To further compensate for this resource availability problem, in some embodiments, the disclosed system and methodology may evaluate a generated network after initialization and without training (or without complete training) to decide on the “best” candidate. This may be satisfactory, as it has been shown² that a model's performance can be approximated after initialization with respect to different data samples. This may be a good enough indicator of the performance of the corresponding fully trained network. ² Mellor, Joseph, et al. “Neural architecture search without training”; arXiv preprint arXiv:2006.04647 (2020), and Standley, Trevor, et al. “Which tasks should be learned together in multi-task learning?”; International Conference on Machine Learning. PMLR, 2020.

The search space of candidate architectures (A) can be thought of as a complete graph represented by a directed acyclic graph (DAG), where each architecture is a sampled subgraph generated by the controller, and one that could be selected as an optimal architecture if it results in the “best” performance. The system considers the entire search space as a DAG with N nodes, with each node representing a possible structure for a recurrent neural network cell. In some embodiments, the controller (such as an RNN) identifies/decides which edges between the nodes are activated (traversed) and which computations are performed at each node as part of the network architecture evaluation process.

Next, the disclosed process generates a candidate neural network architecture, in the form of an attention based RNN. As mentioned, a RNN controller or other form of agent may be used in a process to generate the candidate architecture. The tensor formed from the user data is input to the candidate neural network to generate an output. The performance of the candidate neural network is then determined. If the performance has not reached a plateau, then the performance evaluation may be fed back into the controller or a search algorithm as a form of reinforcement learning (RL) to generate a more optimal architecture. This feedback loop continues until the performance has plateaued. Within the context of the disclosed approach, the resulting neural network architecture and underlying data representation are then considered to be optimal for the task or objective.

Although this describes an effective process for selecting a neural network architecture and associated data representation that is optimal for a single task/objective, businesses often need to optimize a process while considering multiple goals or objectives. In this situation, one could choose to train separate networks to achieve each of the multiple goals. However, this would be both computationally and time intensive, and may not be practical.

Instead, an alternative approach is to use a multi-task learning framework to train a network for more than a single task. However, as mentioned, not all relevant tasks will benefit from being trained together and training certain tasks together may have a negative impact on the training process. Thus, it is potentially important to the resulting accuracy to select a set or subset of tasks that are expected to efficiently train together.

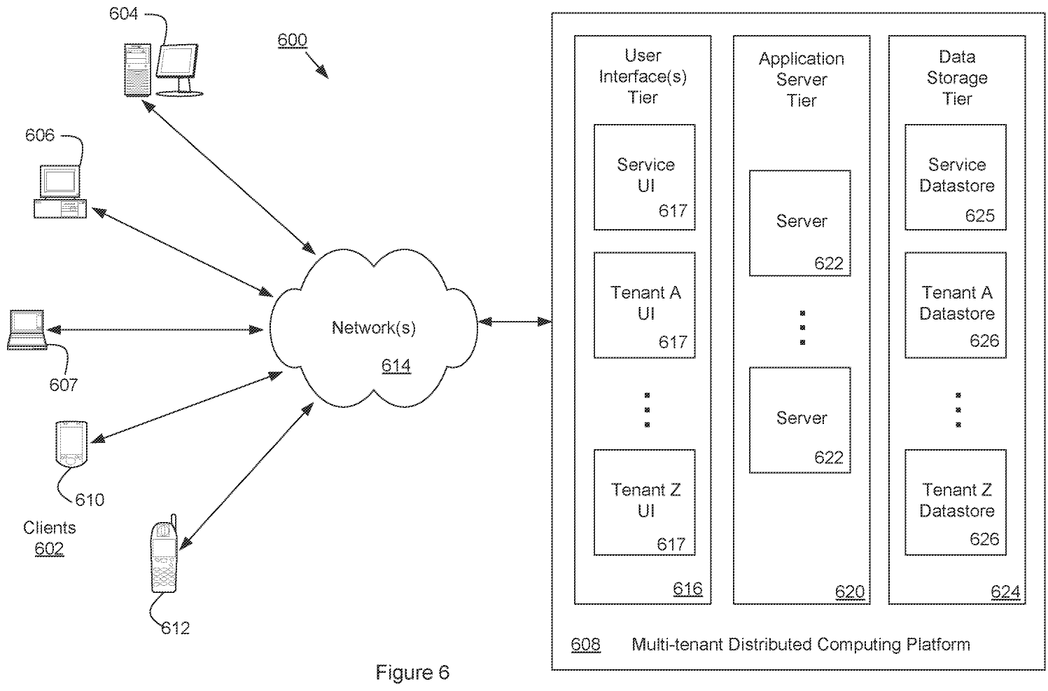

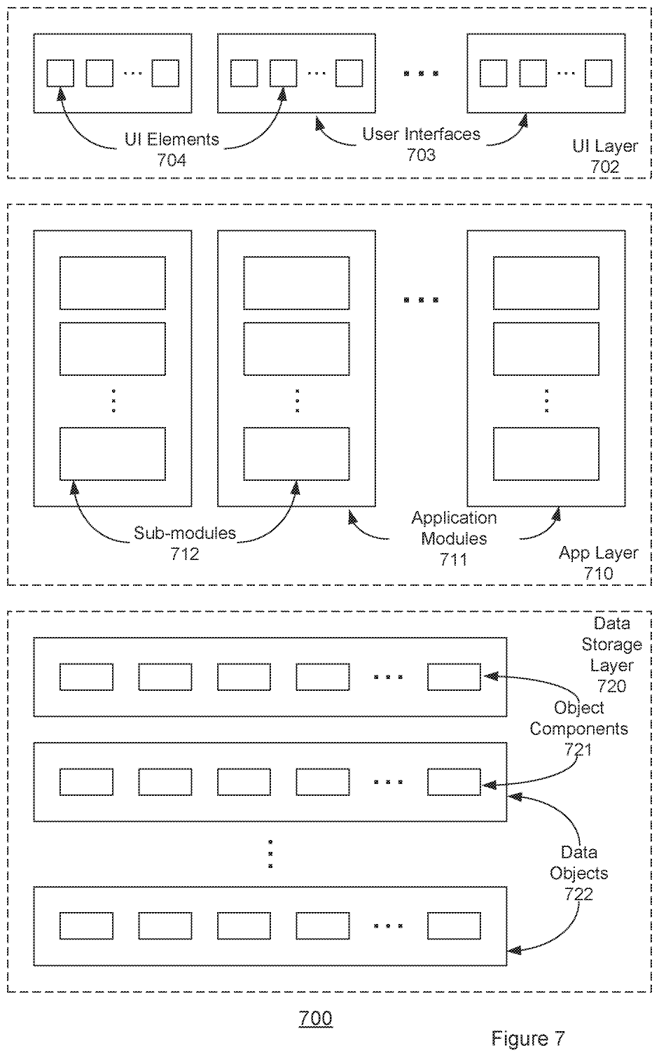

Given a set of N tasks (which may be represented by a set of goals or objectives for a model), this is a combinatorial problem where a system wants to determine how well each task performs when combined with one or more other tasks, resulting in pairwise and higher-order task relationships between the set of N tasks. To that end, in some embodiments, a candidate set of networks contains 2^{N}−1 possible groupings, expressed as C(N,1) networks with one task, C(N,2) networks with two tasks, and so forth. Additionally, there may be candidate architectures chosen by other steps or stages (such as those described with reference to FIG. 5(a)) that perform well and depending on the number of tasks and choice of tasks, one of those could be an optimal architecture.

Given a group of tasks and the “best” neural network architecture choice for each task or objective resulting from the disclosed steps or stages, the problem may be formulated as an optimization problem where each task is assigned to an architecture, with more than one task assigned to an architecture under some circumstances. This allows a set of tasks to be trained together if they benefit (or at least do not substantially degrade) the overall performance of the architecture for one or more of the tasks in the set.

In some embodiments, a “budget” may be specified for the number of separate networks or models that are allowed to be trained (in one embodiment, this is implemented in the form of a constraint ‘t’ on the maximum number of models (neural networks) used to optimize ‘n’ tasks). This forms a constraint on the optimization process.

For multiple goals or objectives, embodiments may change the capacity of the network (such as the number of layers or nodes) and/or the cell structure. This may cause a change to how the controller or algorithm generates a candidate architecture within the search space. For example, when a single task could be classified using a simpler network, if there are 5 objectives, a more complex network may be needed. This means that a part of the change to the process flow is in the search space to be examined, as defined or constrained by the search space parameters. For multiple tasks, an embodiment of the disclosed process can find “best” or optimal candidate architectures for a single task, for a combination of two tasks, and so forth.

This portion of the process flow takes care of the complexity needed for a single task as opposed to that for two tasks, or for five tasks, as examples. For this step, an embodiment of the disclosed process determines an assignment of the selected “best” candidate architectures to the tasks to be performed (this may also be phrased as the converse, an assignment of each task to an optimal architecture, where more than a single task may be assigned to an architecture). The result of this step is a final (and expected to be optimal or close to optimal) assignment of goals or tasks to a “best” neural network architecture for solving each task, taking into consideration the possible impact on the training or inference process arising from assigning more than a single task to an architecture.

FIG. 5(a) is a diagram illustrating an example of a task-architecture assignment. The figure shows 3 different ways or examples of assigning 5 tasks (identified as a, b, c, d, and e in the figure) to 3 candidate architectures (identified as A, B, and C in the figure). There is an overall loss (identified as L₁, L₂, or L₃) associated with each example assignment and the configuration with the optimal loss will be picked as the final configuration choice. Note that a task can be solved using a single architecture and still be included in training with other tasks if it helps the overall performance of the assignment of all tasks to candidate architectures. Note further that in some embodiments, selection of the architecture happens before fully training the network. As disclosed herein, the process first searches over network architectures and then uses those results to train the network(s) and generate a data representation.

As suggested by FIG. 5(a), there are multiple different combinations possible, so the system typically selects the solution that minimizes the overall loss. This ensures each task is solved by an architecture and acts to group related tasks together if they help the overall performance. If a task does not benefit from being trained together with other objectives or will cause negative transfer, then it may be grouped as a single task.

The disclosed process determines an assignment of tasks to each of one or more candidate architectures that results in the optimal (typically the least) overall loss. The overall problem may be defined as a minimization of the overall loss on the set of desired tasks given a limited budget t, where t is the number of separate networks allowed (as mentioned, the constraint ‘t’ is on the maximum number of models (neural networks) used to optimize ‘n’ tasks). To ensure all tasks will be assigned to a network and therefore solved, an infinite loss may be assigned for any unsolved tasks.

This optimization problem is shown to be NP-hard (i.e., a non-deterministic polynomial-time hardness problem, in terms of a reduction from a cover-set) but given the small number of tasks and networks (both typically less than 5), it is expected to be solved faster than fully training all combinations of networks to find the “best” or most optimal choice(s). In some embodiments, to solve this problem, the system uses branch and bound optimization with an approximation strategy for reducing the time complexity, though other approaches are possible and may be used.

One choice for an approximation strategy is to predict higher order network performance from knowledge about lower order networks. For example, given the performance of networks on tasks (A, B), (A, C), and (B, C), the disclosed system may generate an approximation for the performance of a higher order task grouping (A, B, C) by averaging or otherwise combining the lower order network performance(s).

Early stopping of training prior to convergence or limited training using a fraction of the available data are two other approaches that may be used to reduce time complexity and approximate the final network performance. This is because it has been shown that the performance based on using those approaches is correlated with the final network performance. Therefore, one can obtain a good estimate of the final performance (or at least its expected behavior) by using either of these approaches.

Combining the above, an example of an optimization approach is as follows. If the number of tasks is 4 or less, then a brute force approach of optimizing every possible partition of sets is simplest (as with 4 tasks there are only 15 possible partitions). For a larger numbers of tasks, use a branch-and-bound algorithm aimed at minimizing the sum of the loss across all tasks where (1) training with limited epochs and reduced data is used to accelerate estimates of performance and (2) the lower-bound on the performance of a branch is approximated from lower order networks.

Using an implementation of the disclosed processing flow, the system will generate a representation that encodes the user's browsing behavior in time (as an example of user generated data), and that representation can be used in an end-to-end system for predicting a desired goal or objective. These data representations can also be used as a separate layer/module in a different model or network and combined with other types of static data representations that encode different characteristics of users (such as demographic information) to create a more comprehensive model of users and their behavior.

The attention-based approach also enables businesses to perform a targeted search for the most important URLs that are relevant to a particular objective and therefore to better understand their customers. Specifically, when an attention-based model Is used for inference an “attention” vector is generated in addition to the model output. This “attention” vector is the length of the input sequence and sums to one. It indicates how important each element is to the model's output; therefore, businesses can compute statistics on which URL(s) receive the greatest average attention across inferences.

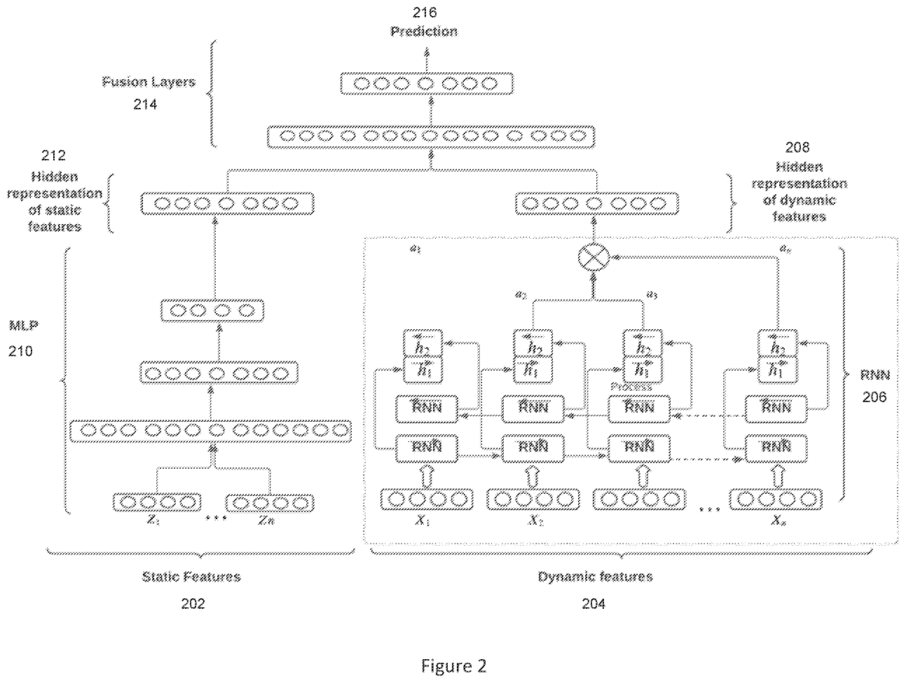

FIG. 2 is a diagram illustrating an example architecture where an attention based bi-directional RNN, or the embeddings extracted from such a model can be used as a component of a separate model. As shown in the figure, a process flow may combine a representation of static features 202 (such as data representing a demographic characteristic of a user) with a representation of dynamic features 204 for the user. As disclosed herein, a representation of the dynamic features may be generated using an RNN. A result of providing the user dynamic data as an input to the RNN is a “model” having a “hidden” layer 208 that is a representation of the dynamic features input to the model. A multi-layer perceptron (MLP)³ 210 may be used to generate a representation of the static features 202, with a hidden layer representation of the static features 212 being extracted from the structure of MLP 210. Hidden layer representations 208 and 212 may then be combined in a fusion layer 214 to generate a data representation for input to a prediction or inference stage 216, which may be a trained machine learning model. ³ A multilayer perceptron (MLP) is a fully connected class of feedforward artificial neural network (ANN). The term MLP is used ambiguously, sometimes loosely to mean any feedforward ANN, sometimes strictly to refer to networks composed of multiple layers of perceptrons (with threshold activation); see § Terminology. Multilayer perceptrons are sometimes colloquially referred to as “vanilla” neural networks, especially when they have a single hidden layer.

As a single task differs from multiple tasks and different tasks differ with respect to each other, the processes described may be repeated for multiple “single tasks” as well as multiple “pairs of tasks”, tuple(s) of tasks, and so on in other combinations to identify a “best” architecture corresponding to each single task or combination of tasks. This allows the processes described to be used to explore a wider range of candidate architectures.

For example, consider a case where a business is interested in predicting a combination of two user behaviors: (1) if users will click on an advertisement if it is shown to them and (2) if the users will make a purchase if the advertisement is presented to them. To generate a prediction, one could first try to identify the best candidate architecture and representation for (1) and the best candidate for (2) as single tasks, and then the best candidate for predicting (1) and (2) in one architecture. The network used for classifying two objectives (the multiple tasks) might benefit from greater capacity and complexity compared to that used for a single task. The approach of generating network architecture candidates based on each single task or different combinations of tasks can be used to generate candidate networks which are evaluated in a later step or stage of the process.

The disclosed approach may be used to generate multiple architectures that have performed well for single tasks, for pairs of tasks, or tuple(s) of tasks, as examples. The process may also have a set of tasks that a model developer would like to have performed, such as classification of different objectives, or regression, as examples. At this point, a task grouping framework may be used, where each task is assigned (alone or in combination with one or more other tasks) to the appropriate architecture based on how well the performance metrics of the proposed assignment approach a maximum value.

For example, assume a task can be solved as a single task, paired with another task, or paired with two other tasks. Each task may be assigned to an architecture where a performance metric such as F1, accuracy, or AVP (as non-limiting examples) for that task is the highest. One can also apply a constraint to the problem to prevent too many tasks being solved as a single task because it is computationally expensive to train separate networks. For example, if there are 5 tasks that one is interested in solving, one could limit the tasks to be solved separately using a single task architecture to 2.⁴ Other forms of constraints or limitations may also be applied, such as for a total number of networks used, or a total number of different architectures used, as examples. ⁴ This approach is discussed further in Standley, Trevor, et al. “Which tasks should be learned together in multi-task learning?.” International Conference on Machine Learning. PMLR, 2020.

FIG. 4(d) is a flow chart or flow diagram illustrating a process, operation, method, or set of functions for generating a representation for a sequence of data as part of a process of generating and evaluating candidate neural network architectures for use with that data and determining an optimal assignment of one or more tasks or objectives to one or more of the candidate architectures, in accordance with some embodiments.

As shown in the figure, a set of processes or operations are used to generate and train candidate neural network architectures (and as a result, to generate candidate data representations as hidden layers). These processes or operations may include one or more of the following, as disclosed herein:
Obtain a Sequential User Data Stream for Each of N Users (such as customers or users of a system) (as suggested by step or stage 402);
For all Users, Convert all Sequence Elements into Vectors of a Fixed Dimensionality (step or stage 404);
Assemble the Vectors Into a Multi-Dimensional Tensor (step or stage 406);
Define a Search Space For a RNN Architecture Search (step or stage 408);
   In some embodiments, the search space may be determined based on one or more network characteristics, including but not limited to number of layers, cell structure, or number of objectives, as examples;
      The search space network characteristics may be set based on available computational resources, training data, training time, or another constraint or consideration;
Generate a First Candidate/Initial Attention Based RNN Architecture for Evaluation (step or stage 410);
   Input the constructed tensor into the first candidate architecture (step or stage 412);
   Candidate architecture creates representation (typically the last hidden layer of the network) and produces an output representing a classification of the task/objective based on the input data in the tensor (step or stage 412);
   Determine one or more performance metrics (such as AVP/F1) for the candidate network architecture and use the metric(s) as part of a feedback loop to generate a new candidate RNN architecture(s) (step or stage 414);
Generate a new candidate RNN Architecture (step or stage 416), using the determined performance metric as an input to the process used to generate the candidate architecture;
   In some embodiments, a controller or search algorithm may be used to generate candidate architecture(s);
      In one embodiment, the controller may be a RNN which receives a performance evaluation metric for a candidate architecture as an input;
   Repeat input of tensor, and determination of performance metric(s) for candidate architecture (steps or stages 418 and 420);
   If performance measure(s) reach plateau, stop (corresponding to the “Yes” branch of step or stage 422);
   If performance does not reach plateau, generate new candidate architecture (corresponding to the “No” branch of step or stage 422, and control flow returns to step or stage 416);
When performance plateau (or other stop point) reached, that architecture is selected as the “best” neural network architecture for the specific task/objective (step or stage 424). Further, the last “hidden” layer of that architecture serves as the representation for the input data that was provided to the architecture in the tensor;
   the generated representation may be used (by transferring a hidden layer into another model or classifier) to combine that set of user generated data with other user related data in making a final classification or decision (for example, as described with reference to FIG. 2).

If desired, following the generation of a candidate neural network architecture and associated data representation, it may be desirable to evaluate the performance of the candidate architecture (or a different candidate architecture found by a search mechanism) for processing and classifying data in the form of the determined representation. In some embodiments, this may be done by determining the accuracy and/or other performance parameters of the representation and architecture when used for a specific task or objective. By repeating the above sequence of steps, it is possible to generate a set of one or more neural network architectures (and associated data representations), with each architecture being determined to be optimal for a specific task or objective (as suggested by step or stage 426).

The problem now becomes one of assigning each of a set of tasks or objectives to a network that is considered optimal for a specific task and determining if the network architecture performance is satisfactory when used for more than a single task (such as by minimizing the impact of assigning a second task to an architecture that is optimal for use with a first task).

In one embodiment, this assignment of a set of tasks or objectives to one or more candidate network architectures may be performed by the following process:
Determine the performance of a candidate neural network and candidate data representation for each of several desired tasks (step or stage 426);
Define an optimization problem to select the “best” combination of networks and tasks/objectives (i.e., the assignment of tasks/objectives or combinations of those to a specific network architecture) (step or stage 428). As described, this may be performed using a branch-and-bound algorithm;
   This may include using a constraint on the number of different network architectures used;
   This may include using a constraint on the total number of networks used;
   This may include generating one or more combinations of tasks and evaluating the ability of a candidate architecture to be used effectively for that combination;
Select Assignment of Multiple Tasks/Objectives to Architecture(s) That Minimizes Overall Loss While Satisfying Constraint(s) on Number of Allowed Neural Networks (step or stage 430); and
Utilize the selected set of architecture(s) and associated representations to construct a trained model for use with that data representation for the specific type of input data;
   In some embodiments this may involve (or instead involve) transferring a hidden layer of a trained network that includes the data representation to another neural network or machine learning model.

FIG. 4(e) is a diagram illustrating elements or components that may be present in a computing device or system configured to implement a method, process, function, or operation in accordance with an embodiment of the system and methods disclosed herein. As noted, in some embodiments, the system and methods may be implemented in the form of an apparatus that includes a processing element and set of executable instructions. The executable instructions may be part of a software application and arranged into a software architecture.

In general, an embodiment may be implemented using a set of software instructions that are designed to be executed by a suitably programmed processing element (such as a GPU, CPU, TPU, QPU, state machine, microprocessor, processor, controller, or computing device, as examples). In a complex application or system such instructions are typically arranged into “modules” with each such module typically performing a specific task, process, function, or operation. The entire set of modules may be controlled or coordinated in their operation by an operating system (OS) or other form of organizational platform.

Each application module or sub-module may correspond to a particular function, method, process, or operation that is implemented by the module or sub-module. Such function, method, process, or operation may include those used to implement one or more aspects of the disclosed systems, apparatuses, and methods.

The application modules and/or sub-modules may include any suitable computer-executable code or set of instructions (as would be executed by a suitably programmed processor, microprocessor, state machine, CPU, GPU, TPU, or QPU, as examples), such as computer-executable code corresponding to a programming language. For example, programming language source code may be compiled into computer-executable code. Alternatively, or in addition, the programming language may be an interpreted programming language such as a scripting language.

The modules may contain one or more sets of instructions for performing a method or function described with reference to the Figures, and the descriptions of the functions and operations provided in the specification. These modules may include those illustrated but may also include a greater number or fewer number than those illustrated. As mentioned, each module may contain a set of computer-executable instructions. The set of instructions may be executed by a programmed processor contained in a server, client device, apparatus, network element, system, platform, or other component.

A module may contain instructions that are executed by a processor contained in more than one of a server, client device, apparatus, network element, system, platform or other component. Thus, in some embodiments, a plurality of electronic processors, with each being part of a separate device, server, or system may be responsible for executing all or a portion of the software instructions contained in an illustrated module. Thus, although FIG. 4(e) illustrates a set of modules which taken together perform multiple functions or operations, these functions or operations may be performed by different devices or system elements, with certain of the modules (or instructions contained in those modules) being associated with those devices or system elements.

As shown in FIG. 4(e), system 431 may represent a server or other form of computing or data processing system, platform, apparatus, or device. Modules 440 each contain a set of executable instructions, where when the set of instructions is executed by a suitable electronic processor or processors (such as that indicated in the figure by “Physical Processor(s) 436”), system (or server, platform, apparatus, or device) 431 operates to perform a specific process, operation, function, or method.

Modules 440 are stored in a memory 432, which typically includes an Operating System module 441 that contains instructions used (among other functions) to access and control the execution of the instructions contained in other modules. The modules 440 stored in memory 432 are accessed for purposes of transferring data and executing instructions by use of a “bus” or communications line 434, which also serves to permit processor(s) 436 to communicate with the modules for purposes of accessing and executing a set of instructions. Bus or communications line 434 also permits processor(s) 436 to interact with other elements of system 431, such as input or output devices 437, communications elements 438 for exchanging data and information with devices external to system 431, and additional memory devices 439.

In some embodiments, the modules 440 may comprise computer-executable software instructions that when executed by one or more electronic processors cause the processors (or a system or apparatus containing one or more of the processors) to perform one or more steps or stages to:
Obtain a Sequential User Data Stream for Each of N Users/Customers (as suggested by module 442);
For all Users, Convert all Sequence Elements into Vectors of a Fixed Dimensionality (Module 443);
Assemble the Vectors Into a Multi-Dimensional Tensor (Module 444);
Define a Neural Network Architecture (RNN) Search Space and Generate an Initial Candidate Neural Network (Module 445);
   In some embodiments, this may be performed with the aid of a controller or search algorithm;
      In one embodiment, the controller may be an RNN;
   In one embodiment, the candidate neural network may be a uni-directional or a bi-directional attention-based RNN;
Use the Multi-Dimensional Tensor as Input to the Initial Candidate Neural Network Architecture Found from the Search (Module 446);
Determine Performance of Candidate Neural Network and Underlying Representation for Desired Task/Objective (Module 447);
   A performance metric or accuracy measure may be fed back into the controller or algorithm (Module 445) to assist in generating a “better” candidate network architecture;
   The preceding processes may be repeated to identify a “best” neural network architecture (and underlying data representation) for each of one or more tasks or objectives;
      In some embodiments, this may be the result of executing the software instructions in modules 445, 446, and 447;
Given a best or optimal neural network architecture for each of one or more tasks or objectives, define and evaluate an optimization problem to select the “best” assignment of networks and tasks/objectives (i.e., the assignment of tasks/objectives or combinations of those to a specific network architecture or architectures) (Module 448);
   This may include using a constraint on the number of networks used;
   This may include generating various combinations of tasks and evaluating the ability of a candidate architecture to be used effectively for that combination;
Select Network Architecture/Data Representation That Minimizes Overall Loss While Satisfying Constraint on Number of Allowed Neural Networks (Module 449); and
Use the Selected Architectures to Generate Predictions for the Tasks they Have Been Assigned or Use the Last Hidden Layer of Selected Architectures as Input to a Subsequent Model (Module 450);
   In some embodiments this may involve transferring a hidden layer of a trained network that includes the data representation to another neural network or machine learning model.

In some embodiments, the functionality and services provided by the system, apparatuses, and methods disclosed herein may be made available to multiple users by accessing an account maintained by a server or service platform. Such a server or service platform may be termed a form of Software-as-a-Service (SaaS). FIGS. 5(b), 6, and 7 are diagrams illustrating an architecture for a multi-tenant or SaaS platform that may be used in implementing an embodiment of the systems, apparatuses, and methods disclosed herein. FIG. 5(b) is a diagram illustrating a SaaS system in which an embodiment may be implemented. FIG. 6 is a diagram illustrating elements or components of an example operating environment in which an embodiment may be implemented. FIG. 7 is a diagram illustrating additional details of the elements or components of the multi-tenant distributed computing service platform of FIG. 6, in which an embodiment may be implemented.

In some embodiments, the system or services disclosed herein may be implemented as microservices, processes, workflows or functions performed in response to the submission of a set of input data. The microservices, processes, workflows or functions may be performed by a server, data processing element, platform, or system. In some embodiments, the data analysis and other services may be provided by a service platform located “in the cloud”. In such embodiments, the platform may be accessible through APIs and SDKs. The functions, processes and capabilities disclosed herein and described with reference to one or more of the Figures may be provided as microservices within the platform. The interfaces to the microservices may be defined by REST and GraphQL endpoints. An administrative console may allow users or an administrator to securely access the underlying request and response data, manage accounts and access, and in some cases, modify the processing workflow or configuration.

Note that although FIGS. 5(b), 6, and 7 illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide one or more of the processes, functions, and operations disclosed herein. Although in some embodiments, a platform or system of the type illustrated in the Figures may be operated by a service provider to provide a specific set of services or applications, in other embodiments, the platform may be operated by a provider and a different entity may provide the applications or services for users through the platform.

FIG. 5(b) is a diagram illustrating a system 500 in which an embodiment may be implemented or through which an embodiment of the services disclosed herein may be accessed. In accordance with the advantages of an application service provider (ASP) hosted business service system (such as a multi-tenant data processing platform), users of the services may comprise individuals, businesses, or organizations, as examples. A user may access the services using a suitable client, including but not limited to desktop computers, laptop computers, tablet computers, scanners, or smartphones. In general, a client device having access to the Internet may be used to provide data to the platform for processing and evaluation. A user interfaces with the service platform across the Internet 508 or another suitable communications network or combination of networks. Examples of suitable client devices include desktop computers 503, smartphones 504, tablet computers 505, or laptop computers 506.

System 510, which may be hosted by a third party, may include a set of data analysis and other services to assist in generating a data representation and generating and evaluating a set of candidate architectures 512, and a web interface server 514, coupled as shown in FIG. 5(b). Either or both the data analysis and other services 512 and the web interface server 514 may be implemented on one or more different hardware systems and components, even though represented as singular units in FIG. 5(b).

Services 512 may include one or more functions or operations for the processing of data to enable the generation of a data representation for a set of sequential data, generate and evaluate a set of candidate neural network architectures that use the data representation, select an optimal architecture or architectures for a task or tasks, and assign a set of tasks (alone or in combination) to the candidate optimal architectures.

As examples, in some embodiments, the set of functions, operations or services made available through the platform or system 510 may include:
Account Management services 516, such as:
   a process or service to authenticate a user wishing to submit an example of sequential data and determine an optimal neural network architecture and data representation;
   a process or service to generate a container or instantiation of the data analysis and network evaluation services for that user;
Initial Data Processing services 517, such as:
   a process or service to obtain a data stream for each of N users;
   a process or service to, for all users, convert all sequence elements into vectors of a fixed dimensionality (for example, using an embedding technique);
      If dealing with a sequence of URLs a user visited, the system would typically look up an embedding for each URL (where, these embeddings are typically built using word2vec-like techniques). However, the system may also (or instead) convert a sequence of URLs into a longer sequence of “words” by extracting known words from the URL strings. The system then uses pre-trained words vectors, applying word2vec. If the input data is a sequence of zip codes, for example, this can be represented as a sequence of (latitude, longitude) pairs;
   a process or service to form a tensor from the generated vectors;
Generate Data Representation and Candidate Architecture services 518, such as:
   a process or service to define a search space for candidate neural network architectures (such as by specifying parameters or characteristics of an RNN);
      examples of parameters include a number of layers or a number of nodes in a layer;
   a process or service to generate an initial candidate architecture for evaluation (optional);
   a process or service to generate candidate architectures using a trained controller agent or search algorithm;
      in one embodiment, the controller may be an RNN;
   a process or service to use the generated tensor as input to a candidate attention-based RNN candidate architecture to generate a data representation (typically as a hidden layer of a trained or partially trained network);
   a process or service to generate an optimal architecture and data representation for each of a set of tasks/objectives;
Evaluate and Select Optimal Architecture services 519, such as:
   a process or service to assign a set of tasks/objectives to a set of one or more candidate architectures optimized for a single task (or in some cases, more than a single task) to minimize loss subject to a constraint on the number of neural networks;
Other Uses of Representation services 520, such as:
   a process or service to transfer a hidden layer of a network (i.e., the data representation) to another classifier or model; and
Administrative services 522, such as:
   a process or services to provide platform and services administration—for example, to enable the provider of the services and/or the platform to administer and configure the processes and services provided to users.

The platform or system shown in FIG. 5(b) may be hosted on a distributed computing system made up of at least one, but typically multiple, “servers.” A server is a physical computer dedicated to providing data storage and an execution environment for one or more software applications or services to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, or web server. A web server is most often a combination of hardware and the software that helps deliver content, commonly by hosting a website, to client web browsers that access the web server via the Internet.

FIG. 6 is a diagram illustrating elements or components of an example operating environment 600 in which an embodiment may be implemented. As shown, a variety of clients 602 incorporating and/or incorporated into a variety of computing devices may communicate with a multi-tenant service platform 608 through one or more networks 614. For example, a client may incorporate and/or be incorporated into a client application (e.g., software) implemented at least in part by one or more of the computing devices. Examples of suitable computing devices include personal computers, server computers 604, desktop computers 606, laptop computers 607, notebook computers, tablet computers or personal digital assistants (PDAs) 610, smart phones 612, cell phones, and consumer electronic devices incorporating one or more computing device components (such as one or more electronic processors, microprocessors, central processing units (CPU), TPUs, GPUs, QPUs, state machines, or controllers). Examples of suitable networks 614 include networks utilizing wired and/or wireless communication technologies and networks operating in accordance with any suitable networking and/or communication protocol (e.g., the Internet).

The distributed computing service/platform (which may also be referred to as a multi-tenant data processing platform) 608 may include multiple processing tiers, including a user interface tier 616, an application server tier 620, and a data storage tier 624. The user interface tier 616 may maintain multiple user interfaces 617, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application, or causing the execution of specific data processing operations, as examples. Each application server or processing element 622 shown in the figure may be implemented with a set of computers and/or components including computer servers and processors, and may perform various functions, methods, processes, or operations as determined by the execution of a software application or set of instructions. The data storage tier 624 may include one or more datastores, which may include a Service Datastore 625 and one or more Tenant Datastores 626. Datastores may be implemented with a suitable data storage technology, including structured query language (SQL) based relational database management systems (RDBMS).

Service Platform 608 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by the execution of one or more modules of software code/instructions by one or more servers 622 that are part of the platform's Application Server Tier 620. As noted with regards to FIG. 5(b), the platform system shown in FIG. 6 may be hosted on a distributed computing system made up of at least one, but typically multiple, “servers.”

Rather than build and maintain such a platform or system themselves, a business may utilize systems provided by a third party. A third party may implement a system/platform as disclosed herein in the context of a multi-tenant platform, where individual instantiations of a business' data processing workflow (such as the data analysis and neural network architecture evaluation services and processing disclosed herein) are provided to users, with each business representing a tenant of the platform. One advantage to such multi-tenant platforms is the ability for each tenant to customize their instantiation of the data processing workflow to that tenant's specific needs or operational methods. Each tenant may be a business or entity that uses the multi-tenant platform to provide services and functionality to multiple users.

FIG. 7 is a diagram illustrating additional details of the elements or components of the multi-tenant distributed computing service platform of FIG. 6, with which an embodiment may be implemented. The software architecture shown in FIG. 7 represents an example of an architecture which may be used to implement an embodiment. In general, an embodiment may be implemented using a set of software instructions that are designed to be executed by a suitably programmed processing element (such as a CPU, GPU, TPU, QPU, state machine, microprocessor, processor, controller, or computing device). In a complex system such instructions are typically arranged into “modules” with each module performing a specific task, process, function, or operation. The entire set of modules may be controlled or coordinated in their operation by an operating system (OS) or other form of organizational platform.

As noted, FIG. 7 is a diagram illustrating additional details of the elements or components 700 of a multi-tenant distributed computing service platform, with which an embodiment may be implemented. The example architecture includes a user interface (UI) layer or tier 702 having one or more user interfaces 703. Examples of such user interfaces include graphical user interfaces and application programming interfaces (APIs). Each user interface may include one or more interface elements 704. Users may interact with interface elements to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 710 may include one or more application modules 711, each having one or more sub-modules 712. Each application module 711 or sub-module 712 may correspond to a function, method, process, or operation that is implemented by the module or sub-module (e.g., a function or process related to providing data processing and services to a user of the platform). Such function, method, process, or operation may include those used to implement one or more aspects of the disclosed system and methods, such as for one or more of the processes or functions described with reference to the Figures:
Obtain a Sequential User Data Stream for Each of N Users;
For all Users, Convert all Sequence Elements Into Vectors of a Fixed Dimensionality;
Assemble the Vectors Into a Multi-Dimensional Tensor;
Define a RNN Search Space and Generate an Initial (or subsequent) Candidate Neural Network;
   In some embodiments, this may be performed with the aid of a controller or search algorithm;
      In one embodiment, the controller may be an RNN;
Use the Tensor as Input to the Initial (or subsequent) Neural Network Architecture Found from the Search;
Determine the Performance of the Initial Neural Network Architecture (in later stages, the performance of a Candidate Architecture) and Underlying Representation for a Desired Task/Objective;
   The performance or accuracy measure/metric may be fed back into the controller or algorithm to assist in generating a “better” network architecture;
   The preceding processes may be repeated to identify a “best” neural network architecture (and underlying data representation) for each of one or more tasks or objectives;
Given a best or optimal neural network architecture for each of one or more tasks or objectives, define and evaluate an optimization problem to select the “best” combination of networks and tasks/objectives (i.e., the assignment of each task/objective or combination of tasks/objectives to a specific network architecture);
   This may include using a constraint on the number of networks;
   This may include generating combinations of tasks and evaluating the ability of a candidate architecture to be used effectively for that combination;
Select Architecture(s)/Representation(s) That Minimize Overall Loss While Satisfying Constraint on Number of Allowed Neural Networks; and
Use the Selected Architectures to Generate Predictions for the Tasks they Have Been Assigned or Use the Last Hidden Layer of Selected Architectures as Input to a Subsequent Model;
   In some embodiments this may involve transferring a hidden layer of a trained network that includes the data representation to another neural network or machine learning model.

The application modules and/or sub-modules may include any suitable computer-executable code or set of instructions (e.g., as would be executed by a suitably programmed processor, microprocessor, GPU, TPU, QPU, state machine, or CPU, as examples), such as computer-executable code corresponding to a programming language. For example, programming language source code may be compiled into computer-executable code. Alternatively, or in addition, the programming language may be an interpreted programming language such as a scripting language. Each application server (e.g., as represented by element 622 of FIG. 6) may include each application module. Alternatively, different application servers may include different sets of application modules. Such sets may be disjoint or overlapping.

The data storage layer 720 may include one or more data objects 722 each having one or more data object components 721, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each datastore in the data storage layer may include each data object. Alternatively, different datastores may include different sets of data objects. Such sets may be disjoint or overlapping.

Note that the example computing environments depicted in FIGS. 5(b), 6, and 7 are not intended to be limiting examples. Further environments in which an embodiment may be implemented in whole or in part include devices (including mobile devices), software applications, systems, apparatuses, networks, SaaS platforms, IaaS (infrastructure-as-a-service) platforms, or other configurable components that may be used by multiple users for data entry, data processing, application execution, or data review.

The embodiments disclosed herein can be implemented in the form of control logic using computer software in a modular or integrated manner. Based on the disclosure and teachings provided herein, a person of ordinary skill in the art will know and appreciate other ways and/or methods to implement one or more embodiments using hardware, software, and/or a combination of hardware and software.

In some embodiments, certain of the methods, processes, operations, or functions disclosed herein may be implemented in the form of a trained neural network or a model generated using a machine learning algorithm. The machine learning algorithm may be implemented by the execution of a set of computer-executable instructions. The instructions may be stored in (or on) a non-transitory computer-readable medium and executed by a programmed processor or processing element. The set of instructions may be conveyed to a user through a transfer of instructions or an application that executes a set of instructions over a network (e.g., the Internet). The set of instructions or an application may be utilized by an end-user through access to a SaaS platform, self-hosted or on-premise software, or a service provided through a remote platform.

A trained neural network, trained machine learning model, or other form of decision or classification process may be used to implement one or more of the methods, functions, processes, or operations disclosed herein. Note that a neural network or deep learning model may be characterized in the form of a data structure in which are stored data representing a set of layers containing nodes, and (weighted) connections between nodes in different layers are created (or formed) that operate on an input to provide a decision or value as an output.

In general terms, a neural network may be viewed as a system of interconnected artificial “neurons” or nodes that exchange messages between each other. The connections have numeric weights that are “tuned” during a training process, so that a properly trained network will respond correctly when presented with an image or pattern to recognize (for example). In this characterization, the network consists of multiple layers of feature-detecting “neurons”. Each layer has neurons that respond to different combinations of inputs from the previous layers. Training of a network is performed using a “labelled” dataset of inputs in an assortment of representative input patterns that are associated with the intended output response. Training uses general-purpose methods to iteratively determine the weights for intermediate and final feature neurons. In terms of a computational model, each neuron may calculate the dot product of inputs and weights, adds the bias, and apply a non-linear trigger or activation function (for example, a sigmoid response function).

Machine learning (ML) is being used to enable the analysis of data and assist in making decisions in multiple industries. To benefit from using machine learning, a machine learning algorithm is applied to a set of training data and labels to generate a “model” which represents what the application of the algorithm has “learned” from the training data. Each element (or example, in the form of one or more parameters, variables, characteristics or “features”) of the set of training data is associated with a label or annotation that defines how the element should be classified by a trained model. When trained, a model will operate on a new element of input data to generate the correct label or classification as an output.

This disclosure includes the following embodiments and clauses:

1. A method, comprising:

for each of one or more desired tasks, determining a candidate neural network architecture and a data representation, and evaluating the performance of the candidate neural network, wherein the candidate neural network is determined and evaluated by;
obtaining a sequential data stream for each of N users;
converting each element of each user's sequential data stream into an m-dimensional vector;
assembling the m-dimensional vectors into a multi-dimensional tensor;
defining a search space for a candidate neural network architecture, wherein the neural network architecture is an attention-based RNN;
generating one or more candidate neural network architectures within the search space;
for each generated candidate neural network architecture, using one or more tensors formed from the obtained user data streams as an input to the candidate neural network to evaluate the candidate neural network architecture and to generate a candidate data representation for the input user data;

defining and evaluating an optimization process to determine an assignment of each of the one or more desired tasks to one of the generated candidate neural network architectures, where the assignment minimizes an overall loss; and

utilizing the assigned neural network architecture and data representation for the set of user data to construct a trained model for use with the data representation.

2. The method of clause 1, wherein the candidate neural network architectures are generated using an RNN controller agent.

3. The method of clause 1, further comprising introducing the data representation into a classifier or model.

4. The method of clause 1, wherein the optimization process comprises grouping two or more of the tasks and determining the overall loss when the group is used as an objective for each of the candidate neural network architectures.

5. The method of clause 1, further comprising combining one or more static features of a user with the data representation and using the combination as an input to a trained model.

6. The method of clause 1, wherein the search space parameters include one or more of a number of layers, a number of nodes, or a cell structure for the network.

7. The method of clause 1, wherein the optimization process is subject to a constraint on a number of allowed neural networks.

8. A system, comprising:
one or more electronic processors configured to execute a set of computer-executable instructions; and
one or more non-transitory data storage media containing the set of computer-executable instructions, wherein when executed, the instructions cause the one or more electronic processors to
for each of one or more desired tasks, determine a candidate neural network architecture and a data representation, and evaluate the performance of the candidate neural network, wherein the candidate neural network is determined and evaluated by;
   obtaining a sequential data stream for each of N users;
   converting each element of each user's sequential data stream into an m-dimensional vector;
   assembling the m-dimensional vectors into a multi-dimensional tensor;
   defining a search space for a candidate neural network architecture, wherein the neural network architecture is an attention-based RNN;
   generating one or more candidate neural network architectures within the search space; and
   for each generated candidate neural network architecture, using one or more tensors formed from the obtained user data streams as an input to the candidate neural network to evaluate the candidate neural network architecture and to generate a candidate data representation for the input user data;
define and evaluate an optimization process to determine an assignment of each of the one or more desired tasks to one of the generated candidate neural network architectures, where the assignment minimizes an overall loss; and
utilize the assigned neural network architecture and data representation for the set of user data to construct a trained model for use with the data representation.

9. The system of clause 8, wherein the candidate neural network architectures are generated using an RNN controller agent.

10. The system of clause 9, wherein the instructions further cause the one or more electronic processors to introduce the data representation into a classifier or model.

11. The system of clause 8, wherein the optimization process comprises grouping two or more of the tasks and determining the overall loss when the group is used as an objective for each of the candidate neural network architectures.

12. The system of clause 8, wherein the instructions further cause the one or more electronic processors to combine one or more static features of a user with the data representation and use the combination as an input to a trained model.

13. The system of clause 8, wherein the search space parameters include one or more of a number of layers, a number of nodes, or a cell structure for the network.

14. The system of clause 8, wherein the optimization process is subject to a constraint on a number of allowed neural networks.

15. One or more non-transitory computer-readable media comprising a set of computer-executable instructions that when executed by one or more programmed electronic processors, cause the processors to:

for each of one or more desired tasks, determine a candidate neural network architecture and a data representation, and evaluate the performance of the candidate neural network, wherein the candidate neural network is determined and evaluated by;
obtaining a sequential data stream for each of N users;
converting each element of each user's sequential data stream into an m-dimensional vector;
assembling the m-dimensional vectors into a multi-dimensional tensor;
defining a search space for a candidate neural network architecture, wherein the neural network architecture is an attention-based RNN;
generating one or more candidate neural network architectures within the search space; and
for each generated candidate neural network architecture, using one or more tensors formed from the obtained user data streams as an input to the candidate neural network to evaluate the candidate neural network architecture and to generate a candidate data representation for the input user data;

define and evaluate an optimization process to determine an assignment of each of the one or more desired tasks to one of the generated candidate neural network architectures, where the assignment minimizes an overall loss; and

utilize the assigned neural network architecture and data representation for the set of user data to construct a trained model for use with the data representation.

16. The one or more non-transitory computer-readable media of clause 15, wherein the candidate neural network architectures are generated using an RNN controller agent.

17. The one or more non-transitory computer-readable media of clause 15, wherein the instructions further cause the one or more electronic processors to introduce the data representation into a classifier or model.

18. The one or more non-transitory computer-readable media of clause 15, wherein the optimization process comprises grouping two or more of the tasks and determining the overall loss when the group is used as an objective for each of the candidate neural network architectures.

19. The one or more non-transitory computer-readable media of clause 15, wherein the instructions further cause the one or more electronic processors to combine one or more static features of a user with the data representation and use the combination as an input to a trained model.

20. The one or more non-transitory computer-readable media of clause 15, wherein the search space parameters include one or more of a number of layers, a number of nodes, or a cell structure for the network.

The software components, processes, or functions disclosed may be implemented as software code to be executed by a processor using a suitable computer language such as Python, Java, JavaScript, C++, or Perl and using conventional or object-oriented techniques. The software code may be stored as a series of instructions, or commands in (or on) a non-transitory computer-readable medium, such as a random-access memory (RAM), a read only memory (ROM), a magnetic medium such as a hard-drive or a floppy disk, or an optical medium such as a CD-ROM.

In this context, a non-transitory computer-readable medium is most any medium suitable for the storage of data or an instruction set aside from a transitory waveform. Any such computer readable medium may reside on or within a single computational apparatus and may be present on or within different computational apparatuses within a system or network. Further, the set of instructions may be conveyed to a user through a transfer of instructions or an application that executes a set of instructions over a network (e.g., the Internet). The set of instructions or an application may be utilized by an end-user through access to a SaaS platform or a service provided through such a platform.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HDDVD) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps and application programs stored on removable and non-removable memory media, to off-load data from a device, or to upload data to a device. With regards to the embodiments disclosed herein, a non-transitory computer-readable medium may include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. One or more blocks of the block diagrams, or one or more stages or steps of the flowcharts or flow diagrams, and combinations of blocks in the block diagrams and stages or steps of the flowcharts or flow diagrams, can be implemented by computer-executable program instructions. Note that in some embodiments, one or more of the blocks, stages, or steps may not need to be performed in the order presented or may not need to be performed at all.

The computer-executable program instructions may be loaded onto a general-purpose computer, a special purpose computer, a processor, or other programmable data processing apparatus to produce a specific example of a machine. The instructions are executed by the computer, processor, or other programmable data processing apparatus to create means for implementing one or more of the functions, operations, processes, or methods disclosed herein. The computer program instructions may be stored in a computer-readable memory that can direct a computer or other programmable data processing apparatus to function in a specific manner. In this example, the instructions stored in the computer-readable memory produce an article of manufacture including instruction means that implement one or more of the functions, operations, processes, or methods disclosed herein.

While certain implementations of the disclosed technology have been described in connection with what is presently considered to be the most practical implementation, it is to be understood that the technology is not limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the system, technology, apparatus, and methods, and to enable a person skilled in the art to practice implementations of the disclosed technology, including making and using devices or systems and performing the incorporated methods. The patentable scope of an implementation of the disclosed technology is defined in the claims, and may include other examples that occur to those skilled in the art. Such other examples are within the scope of the claims if they have structural and/or functional elements that do not differ from the literal language of the claims, or if they include structural and/or functional elements with insubstantial differences from the literal language of the claims.

All references, including publications, patent applications, and issued patents, cited herein are hereby incorporated by reference to the same extent as if each reference were individually and specifically indicated to be incorporated by reference and/or were set forth in its entirety herein.

The use of the terms “a” and “an” and “the” and similar references in the specification and in the claims are to be construed to cover both the singular and the plural, unless otherwise indicated herein or clearly contradicted by the context. The terms “having,” “including,” “containing” and similar references in the specification and in the claims are to be construed as open-ended terms (e.g., meaning “including, but not limited to,”) unless otherwise noted.

Recitation of ranges of values are intended to serve as a shorthand method of referring individually to each separate value inclusively falling within the range, unless otherwise indicated, and each separate value is incorporated into the specification as if it were individually recited herein. Methods, functions, operations, or processes disclosed herein can be performed in any suitable order unless otherwise indicated or clearly contradicted by context. The use of examples, or exemplary language (e.g., “such as”) is intended to illustrate embodiments of the disclosure and does not pose a limitation unless otherwise claimed. Language in the specification should not be construed as indicating a non-claimed element as being essential to each embodiment.

As used herein in the specification, figures, and claims, the term “or” is used inclusively to refer items in the alternative and in combination.

Different arrangements of the components, elements, or process steps illustrated in the drawings or disclosed, as well as components, elements, or steps not shown are possible. Similarly, some features and sub-combinations are useful and may be employed without reference to other features and sub-combinations. Specific embodiments have been described for illustrative and not for restrictive purposes, and alternative embodiments will be apparent to readers of this disclosure. Accordingly, the disclosure is not limited to the embodiments described or illustrated in the drawings, and embodiments and modifications can be made without departing from the scope of the claims below.

What is claimed is:

1. A method, comprising:
for each of one or more desired tasks, determining a candidate neural network architecture and a data representation, and evaluating the performance of the candidate neural network, wherein the candidate neural network is determined and evaluated by;
obtaining a sequential data stream for each of N users;
converting each element of each user's sequential data stream into an m-dimensional vector;
assembling the m-dimensional vectors into a multi-dimensional tensor;
defining a search space for a candidate neural network architecture, wherein the neural network architecture is an attention-based RNN;
generating one or more candidate neural network architectures within the search space;
for each generated candidate neural network architecture, using one or more tensors formed from the obtained user data streams as an input to the candidate neural network to evaluate the candidate neural network architecture and to generate a candidate data representation for the input user data;
defining and evaluating an optimization process to determine an assignment of each of the one or more desired tasks to one of the generated candidate neural network architectures, where the assignment minimizes an overall loss; and
utilizing the assigned neural network architecture and data representation for the set of user data to construct a trained model for use with the data representation.

2. The method of claim 1, wherein the candidate neural network architectures are generated using an RNN controller agent.

3. The method of claim 1, further comprising introducing the data representation into a classifier or model.

4. The method of claim 1, wherein the optimization process comprises grouping two or more of the tasks and determining the overall loss when the group is used as an objective for each of the candidate neural network architectures.

5. The method of claim 1, further comprising combining one or more static features of a user with the data representation and using the combination as an input to a trained model.

6. The method of claim 1, wherein the search space parameters include one or more of a number of layers, a number of nodes, or a cell structure for the network.

7. The method of claim 1, wherein the optimization process is subject to a constraint on a number of allowed neural networks.

8. A system, comprising:
one or more electronic processors configured to execute a set of computer-executable instructions; and
one or more non-transitory data storage media containing the set of computer-executable instructions, wherein when executed, the instructions cause the one or more electronic processors to
for each of one or more desired tasks, determine a candidate neural network architecture and a data representation, and evaluate the performance of the candidate neural network, wherein the candidate neural network is determined and evaluated by;
obtaining a sequential data stream for each of N users;
converting each element of each user's sequential data stream into an m-dimensional vector;
assembling the m-dimensional vectors into a multi-dimensional tensor;
defining a search space for a candidate neural network architecture,
wherein the neural network architecture is an attention-based RNN;
generating one or more candidate neural network architectures within the search space; and
for each generated candidate neural network architecture, using one or more tensors formed from the obtained user data streams as an input to the candidate neural network to evaluate the candidate neural network architecture and to generate a candidate data representation for the input user data;
define and evaluate an optimization process to determine an assignment of each of the one or more desired tasks to one of the generated candidate neural network architectures, where the assignment minimizes an overall loss; and
utilize the assigned neural network architecture and data representation for the set of user data to construct a trained model for use with the data representation.

9. The system of claim 8, wherein the candidate neural network architectures are generated using an RNN controller agent.

10. The system of claim 9, wherein the instructions further cause the one or more electronic processors to introduce the data representation into a classifier or model.

11. The system of claim 8, wherein the optimization process comprises grouping two or more of the tasks and determining the overall loss when the group is used as an objective for each of the candidate neural network architectures.

12. The system of claim 8, wherein the instructions further cause the one or more electronic processors to combine one or more static features of a user with the data representation and use the combination as an input to a trained model.

13. The system of claim 8, wherein the search space parameters include one or more of a number of layers, a number of nodes, or a cell structure for the network.

14. The system of claim 8, wherein the optimization process is subject to a constraint on a number of allowed neural networks.

15. One or more non-transitory computer-readable media comprising a set of computer-executable instructions that when executed by one or more programmed electronic processors, cause the processors to:
for each of one or more desired tasks, determine a candidate neural network architecture and a data representation, and evaluate the performance of the candidate neural network, wherein the candidate neural network is determined and evaluated by;
obtaining a sequential data stream for each of N users;
converting each element of each user's sequential data stream into an m-dimensional vector;
assembling the m-dimensional vectors into a multi-dimensional tensor;
defining a search space for a candidate neural network architecture, wherein the neural network architecture is an attention-based RNN;
generating one or more candidate neural network architectures within the search space; and
for each generated candidate neural network architecture, using one or more tensors formed from the obtained user data streams as an input to the candidate neural network to evaluate the candidate neural network architecture and to generate a candidate data representation for the input user data;
define and evaluate an optimization process to determine an assignment of each of the one or more desired tasks to one of the generated candidate neural network architectures, where the assignment minimizes an overall loss; and
utilize the assigned neural network architecture and data representation for the set of user data to construct a trained model for use with the data representation.

16. The one or more non-transitory computer-readable media of claim 15, wherein the candidate neural network architectures are generated using an RNN controller agent.

17. The one or more non-transitory computer-readable media of claim 15, wherein the instructions further cause the one or more electronic processors to introduce the data representation into a classifier or model.

18. The one or more non-transitory computer-readable media of claim 15, wherein the optimization process comprises grouping two or more of the tasks and determining the overall loss when the group is used as an objective for each of the candidate neural network architectures.

19. The one or more non-transitory computer-readable media of claim 15, wherein the instructions further cause the one or more electronic processors to combine one or more static features of a user with the data representation and use the combination as an input to a trained model.

20. The one or more non-transitory computer-readable media of claim 15, wherein the search space parameters include one or more of a number of layers, a number of nodes, or a cell structure for the network.
